(19) United States
(12) Patent Application Publication
(10) Pub. No.: US 2024/0043715 A1
(43) Pub. Date: Feb. 8, 2024

(54) EPOXY-BASED PROTECTIVE COATING PRODUCT

(71) Applicant: PHARMAPAINT S.R.L., Florence (IT)

(72) Inventor: Paola DE CRESCENZO, Florence (IT)

(21) Appl. No.: 18/170,860

(22) Filed: Feb. 17, 2023

(30) Foreign Application Priority Data
Aug. 3, 2022 (IT) 102022000016488

(51) Int. Cl. C09D 163/00; C09D 133/08; C09D 179/02

(52) U.S. Cl. CPC C09D 163/00; C09D 133/08; C09D 179/02

(57) ABSTRACT

Described is an epoxy-based protective coating product comprising a mixture of an acrylic resin, an epoxy resin and at least one complex amine wherein the ratio by weight of said acrylic and epoxy resins with said at least one complex amine is greater than 20:1.

This application claims priority to Italian Patent Application 102022000016488 filed Aug. 3, 2022, the entirety of which is incorporated by reference herein.

This invention relates to an epoxy-based protective coating product.

In particular, the invention relates to a protective coating product for protecting a wide range of supports such as, for example, plaster, bricks, iron, wood, MDF, lightweight alloys, cement, glass, fibreglass, plastic, polypropylene, ABS, polyethylene.

Epoxy-based protective coating products are currently known, of the water-based or in any case solvent-free type, which, although providing a suitable protective layer to the support on which they are applied, have considerable drawbacks.

One major drawback is due to the fact that the prior art epoxy-based protective products have a limited “pot-life”, that is to say, a limited time in which it is possible to use them starting from the moment the basic mixture is prepared for making the prior art protective product.

Generally speaking, in the prior art epoxy-based protective coating products, the “pot-life” time is unlikely to be greater than 90 minutes due precisely to the purely epoxy nature of the prior art products.

Another major drawback is due to the fact that the prior art epoxy-based protective coating products have long times for a correct over-painting, approximately greater than 5-6 hours.

Over-painting means the time required between spreading a first coat of product on the support and the possibility of spreading the next coat on the support.

The above-mentioned drawbacks make the prior art protective products not optimised in terms of use in a wide range of contexts of use.

In fact, in order to “cover” a standard working day (approximately 10 hours) it is necessary for the operator to mix the product several times, thus losing operating time and considerably increasing the risk of making errors in the mixing.

The preparation of the mixture is in effect a function of the weighing of the various components, amongst other things, often not with a 1:1 ratio.

The aim of the invention is therefore to provide an epoxy-based protective coating product capable of overcoming the drawbacks of the prior art.

Another aim of the invention is to provide an epoxy-based protective coating product with a “pot-life” of at least 10 hours from the first mixing.

This aim is designed to allow, starting from a first and single mixing, the application of three coats of the product according to the invention during the standard working day (8-10 hours).

A further aim is to provide an epoxy-based protective coating product which is suitable for being applied on supports of various types, such as, for example, plaster, bricks, iron, wood, MDF, lightweight alloys, cement, glass, fibreglass, plastic, polypropylene, ABS, polyethylene.

The above aims are achieved by an epoxy-based protective coating product comprising the technical features described in one or more of the accompanying claims.

Further features and advantages of the invention are more apparent in the non-limiting description which follows of a preferred embodiment of an epoxy-based protective coating product.

The epoxy-based protective coating product according to the invention comprises a mixture of an acrylic resin, an epoxy resin and at least one complex amine.

The weight ratio between the sum of the resins, acrylic and epoxy, with the at least one complex amine is greater than 20:1.

With a ratio greater than 20:1 (19:1, 18:1, 17:1 . . . ) it is understood that, for example, if the sum in weight of the two resins is 20 grams the presence in the mixture of at least one complex amine will be of a minimum of 1 gram.

It is understood that the ratio may also exceed 1:1 with the weight of the complex amines greater than the total weight of the two resins.

Advantageously, the acrylic resin has a minimum temperature of filming of between 40° and 50°.

The minimum filming temperature is the minimum temperature at which the resin starts to dry after application on the support.

For example, advantageously, the acrylic resin is a MAINCOTE AF400® resin.

Advantageously, moreover, the epoxy resin is a resin with a long-chain reaction of Bisphenol A and ethylene oxide-epichlorohydrin, also called Oxirane.

Moreover, advantageously, the epoxy resin is an emulsion resin selected between CAS 25068-38-6 or 25036-25-3.

Advantageously, moreover, the at least one complex amine comprises at least one or more selected between amine CAS 9046-10-0, amine CAS 124-68-5, amine CAS 941-395-8.

According to various embodiments of the invention the product comprises at least two of the above-mentioned complex amines.

For sake of completeness only, CAS (Chemical Abstract Service) is a numeric identifier designed to uniquely identify any chemical substance.

It is useful to identify these CAS numbers in the present invention since most molecular databases currently permit searches based on the CAS number.

The CAS number consists of three sequences of numbers separated by dashes.

The first group consists of a variable number of digits, up to six, the second group consists of two digits, whilst the third and last groups consists of a single digit which serves as a control code.

The above-mentioned numbers are assigned in progressive order relative to the entry in the various databases and do not therefore have any chemical meaning.

Advantageously, the epoxy-based protective product according to the invention also comprises at least one additive selected between coloured pigments, organic phosphorus compound CAS 7320-34-5, fillers, wetting additives, dispersing additives, canning preservatives, coalescing additives, cellulosic thickeners, acrylic and polyurethane thickeners, substrate wetting additives, antifoaming additives, benthic thickeners, dispersing additives, acrylic and polyurethane thickeners, anti-algae and antibacterial additives, epoxy-silane additives CAS 2019-784-2.

Moreover, advantageously, the ratio by weight of the mixture constituting the protective product according to the invention is as follows:
acrylic resin of between 10% and 20% by weight,
epoxy resin of between 30% and 60% by weight,
at least one complex amine of between 10% and 20% by weight.

According to the embodiments in which there is also at least one additive as described above, this is included in the mixture between 0% and 50% by weight.

In the protective coating product according to the invention, the acrylic resin performs the function of binding agent as well as the function performed by the epoxy resin in emulsion.

The epoxy resin also gives the product strength, adhesion and seal over time.

The complex amine CAS 9046-10-0 is an epoxy resin hardener and is also an alkaline pH regulator.

The complex amine CAS 941-395-8 is a hardener for epoxy resins in two-component systems.

The complex amine CAS 124-68-5 is a pH regulator inside the product.

According to the embodiments in which there are additives, and in particular there are benthic thickeners, these, after having been hydrated with water, allow the suspension of any fillers, pigments and binders to be maintained in a homogeneous form, forming a supporting structure for the protective product according to the invention.

Again with reference to the additives, the presence of canning preservatives (anti-mould function as the protective product is contained in its can) uses a mixture comprising a preparation of silanes, amines, chelating agents, and stabilisers with addition of potassium hydroxide, TMDEA and quaternary ammonium salt, ethoxylated alcohol C10-16, Silanetriol, 1-methyl-, potassium salt (1:3) CAS 65351-55-5.

The presence of this preservative makes the protective coating product protected inside the container without using, as in the prior art, toxic and irritating products, such as, for example, isothiazolinone and derivatives.

Moreover, the epoxy additives, when present, improve adhesion of the protective coating product according to the invention when applied on various supports as well as resistance to immersion.

Examples of possible different formulations of the protective coating product according to the invention are given below.

### EXAMPLE 1

### Two-Component Protective Finishing Product

Suitable for example for protecting indoor and outdoor floors, interior walls, especially in high humidity environments such as bathrooms, kitchens and cellars.

### Component 1—Epoxy Resin+Additives

| Raw material | % by weight |
|---|---|
| Water | 11.370 |
| Epoxy resin | 38.180 |
| Epoxy resin | 4.545 |
| Benthic thickener | 0.455 |
| Filler | 36.360 |
| Substrate wetting additive | 9.090 |

### Component 2—Acrylic Resin+Complex Amines and Additives

| Raw material | % by weight |
|---|---|
| Water | 6.852 |
| Cellulosic thickener | 0.182 |
| Substrate wetter | 0.273 |
| Acrylic thickener | 0.640 |
| Amine CAS 9046-10-0 | 8.051 |
| Amine CAS 941-395-8 | 4.545 |
| Acrylic resin AF 400 | 17.250 |
| Filler | 60.470 |
| Pigment | 1.646 |
| Anti-foaming additive | 0.091 |

### EXAMPLE 2

### Two-Component Paint for Tiles and Floors

Two-component paint with long pot-life (10 hours) for painting difficult supports, such as ceramic floors, sanitary tiles, cisterns, etc.

### Component 1—Epoxy Resin+Additives

| Raw material | % by weight |
|---|---|
| Water | 22.000 |
| Benthic thickener | 0.245 |
| Dispersing additive | 0.750 |
| Pigment | 22.380 |
| Epoxy resin | 47.250 |
| Inorganic phosphorus compound | 3.200 |
| Canning preservative | 1.000 |
| Coalescing additive | 2.212 |
| Anti-foaming additive | 0.275 |
| Polyurethane thickener | 0.688 |

### Component 2—Acrylic Resin+Complex Amines+Additives

| Raw material | % |
|---|---|
| Water | 30.000 |
| Benthic thickener | 0.500 |
| Dispersing additive | 5.700 |
| Pigment | 31.620 |
| Amine CAS 9046-10-0 | 9.500 |
| Amine CAS 941-395-8 | 5.000 |
| Amine CASES 24-68-5 | 0.700 |
| Adhesion promoter | 0.200 |
| Substrate wetter | 0.350 |
| Wetting additive | 0.100 |
| Anti-foaming additive | 0.300 |
| Acrylic thickener | 1.030 |
| Amine CAS 9046-10-0 | 4.000 |
| Acrylic resin AF 400 | 10.000 |
| Canning preservative | 1.000 |

The protective product according to the invention can be made by the following process.

A vertical disperser is used as a mixing tool with the capacity to put the main container under a vacuum and also to keep it cooled to temperatures of approximately 30° C.

A first step of the production process consists in inserting the components of the mixture of the protective product in the disperser and then creating the vacuum in it and actuating the mixing for approximately 40 minutes.

Subsequently, the vacuum is deactivated by re-introducing air inside the disperser and reducing the mixing speed; this being maintained for a further 90 minutes.

The above-mentioned second step of the process occurs advantageously at a temperature of approximately 30° C.

Advantageously, moreover, between the first step and the second step there is never an interruption of the mixing speed, that is to say, the disperser is always kept actuated.

More in detail, the first step of the process (vacuum) is advantageous since it allows the dispersion of the cellulose and the addition of additives to be accelerated without incorporating air in the process.

The second step, on the other hand, allows the performance of additives to not be compromised.

A protective product according to the invention may be applied on the above-mentioned range of supports, for example by brush, roller or air gun.

This protective product achieves the preset aims and brings important advantages.

A first important advantage consists in the fact that the protective product according to the invention having a “pot-life” of approximately 10 hours allows the operator to perform a single first mixing at the start of the working day without the need to perform new mixing operations during the working day.

This advantage is even more significant since it allows the product according to the invention to be spread in up to three coats without the product contained in the mixing container becoming dry and unusable.

A further advantage consists in the fact that by modifying the presence and the quantity of the various additives it is possible to obtain a protective product having a range of functions and possible applications on various supports.

All of this is obtained using a protective product which does not require the pre-applications of primer or the like on the support to be protected since it guarantees an excellent grip and resistance to detachment.

1. An epoxy-based protective coating product comprising a mixture of:
an acrylic resin,
an epoxy resin and
at least one complex amine wherein the weight ratio of said acrylic and epoxy resins with said at least one complex amine is greater than 20:1.

2. The product according to the preceding claim, wherein said acrylic resin has a minimum filming temperature of between 40° and 50°.

3. The product according to any one of the preceding claims, wherein said epoxy resin is a resin from a long chain reaction of Bisphenol A and epichloridine containing ethylene oxide.

4. The product according to any one of the preceding claims, wherein said epoxy resin is an emulsion resin from a choice of CAS 25068-38-6 or 25036-25-3.

5. The product according to any one of the preceding claims, wherein said at least one complex amine comprises at least one amine CAS 9046-10-0, one amine CAS 124-68-5, one amine CAS 941-395-8.

6. The product according to any one of the preceding claims, further comprising at least one additive of choice from pigments, organic phosphorus compound CAS 7320-34-5, fillers, wetting additives, dispersing additives, canning preservatives, coalescing additives, cellulosic thickeners, acrylic and polyurethane thickeners, substrate wetting additives, antifoaming additives, benthic thickeners, dispersing additives, acrylic and polyurethane thickeners, anti-algae and antibacterial additives, epoxy-silane additives CAS 2019-784-2.

7. The product according to claim 1, wherein said acrylic resin is a MAINCOTE AF400® resin.

8. The product according to any of the preceding claims, wherein the weight ratio of said mixture is as follows:
acrylic resin of between 10% and 20% by weight,
epoxy resin of between 30% and 60% by weight,
at least one complex amine of between 10% and 20% by weight.

9. The product according to claim 6, wherein said at least one additive is included in said mixture between 0% and 50% by weight.
